(19) United States
(12) Patent Application Publication
(10) Pub. No.: US 2008/0260910 A1
(43) Pub. Date: Oct. 23, 2008

(54) COMPOSITIONS USEFUL AS LIVESTOCK FEEDS

(76) Inventor: WILLIAM PITTMAN, Moorhead, MN (US)

Correspondence Address: LAMPEL & ASSOCIATES, P.C., 555 SKOKIE BLVD., SUITE 500, NORTHBROOK, IL, 60062, US

(21) Appl. No.: 12/164,060

(22) Filed: Jun. 29, 2008

Related U.S. Application Data
(63) Continuation-in-part of application No. 11/164,744, filed on Dec. 4, 2005, now abandoned.

(51) Int. Cl. A23K 1/22; A23K 1/16; A23K 1/06

(52) U.S. Cl. 426/72; 426/624; 426/623

(57) ABSTRACT

Compositions suitable for use as livestock feed mixes produced by combination of zeolites and/or activated carbons with at least one by-product of ethanol-producing or other fermentation processes. Vitamins, minerals and/or other substances may be added to the zeolites and/or activated carbons to further increase the nutritional value of the feed mixtures. The feed mixes provided have a lower moisture level than existing feed mixtures while requiring less energy input in a drying step. Feed mixtures produced by methods provided herein have a longer shelf life than existing feed mixes created from the by-products of the ethanol production or other fermentation processes, and have increased nutritional value relative thereto. A method according to the disclosure further results in production of consistent feed mixtures from the by-products of ethanol production and/or other fermentation processes on a plant-to-plant basis.

### CROSS-REFERENCES TO RELATED APPLICATIONS

This application is a Continuation-in-Part of U.S. patent application Ser. No. 11/164,744 filed Dec. 4, 2005, currently still pending, the entire contents of which are herein fully incorporated by reference.

### FIELD OF THE DISCLOSURE

This disclosure relates generally to processes for creating improved livestock feed mixtures. More particularly, it relates to providing livestock feed mixtures using by-products associated with ethanol production and other grain processing and fermentations. Methods according to the disclosure provide for by-products of ethanol production and/or other fermentation processes to have increased nutritional value, easier handling, increased flowability and increased shelf life.

### BACKGROUND

Statements in this section merely provide background information related to the instant disclosure and may not constitute prior art.

By-products of the production of ethanol and or other fermentation processes can include condensed dry solubles (“CDS”), distillers dry grains with solubles “DDGS”), distillers grain with solubles (“DGS”), distillers dry grain (“DDG”), distillers grain (“DG”), wet and dry sugar beet pulp, and other biological material. Distillers dried grains and solubles is a co-product produced by dry mill ethanol plants as a result of fermenting corn starch to produce fuel ethanol and carbon dioxide. Each bushel (25.4 kilograms) of corn fermented in a dry mill ethanol plant will produce approximately 10.2 liters of ethanol, 8.2 kg of carbon dioxide and 8.2 kg of DDGS. Currently, such by-products of the production of ethanol and/or other fermentation processes are frequently fed to livestock as-is, without prior modification or treatment. However, while these by-products are edible, they do not provide a complete additive nutritional diet for the livestock. Because by-products of the ethanol production and other fermentations inherently lack substantial amounts of necessary carbohydrates for livestock, ingestion of such materials do not provide the livestock a complete necessary dietary supplement, since the carbohydrates initially present in grains or other starting materials were converted by enzymes into ethanol and separated from such starting materials. Also, distillers grain by-products produced by most distilleries from ethanol production and/or the products of other fermentation are often not consistent in their nutritional content. As a result, livestock may have digestive problems with constantly being served different compositions of feed mixture.

Further, because such by-products spoil readily when in a moist condition, they must be either substantially dried or fed to the livestock promptly after the ethanol production or other fermentation process. As a result, it is not un-common for by-products of ethanol production and/or other fermentation to be discarded at times, rather than used as a food source.

For nearly fifty years, farmers have been providing feedblocks to livestock in an attempt to compensate for the lack of a proper nutritional diet. These typical feedblocks are sufficient for providing energy, protein, minerals, and/or vitamins to the livestock, and frequently consist of dried molasses, urea, oil seed meal, minerals, and vitamins. Farmers have used zeolites to dry and increase the value of the by-products of ethanol production and other fermentation to create rigid feed blocks. However, such rigid feedblocks are used primarily as supplements, as opposed to a staple food source for the livestock. Such blocks do not comprise activated carbons and/or zeolites to increase the feed value of the by-products of fermentation and/or grain processing.

Feedblock production according to the prior art includes two common methods. The first involves the production of feedblocks from extreme physical compression of materials. According to this method, the by-products of the ethanol production or other fermentation process are poured into molds and subsequently permitted to cure. The second method involves providing by-products of the ethanol production or other fermentation process in a reactive mixture including metal oxides, such as calcium and magnesium oxide, and water bearing nutrient media, such as molasses, and other materials as are known in the art. However, these known feedblocks do not provide a wide range of necessary dietary nutritional supplements.

Moreover, known feed mixtures which include by-products of fermentation and/or grain processing do not utilize activated carbons and/or zeolites in a capacity as absorbent to aid in deactivating or removing aflatoxins (a carcinogenic toxin) and/or mycotoxins (a toxic substance produced by a fungus and especially a mold), or other potential illness-causing substances, caused by ingestion of spoiled or contaminated mixture

Flowability of by-products of the production of ethanol and or other fermentation processes, including Distillers Dried Grains with Solubles (“DDGS ”) is a significant problem for many ethanol manufacturing plants. Particle size, protein, oils, fiber, moisture, the amount of residual sugars and proper cooling of DDGS prior to loading affects the ability of the DDGS to flow in and out of feed bins, trucks, rail cars and containers. This problem is most serious during hot, humid weather and often results in a significant increase in costs due to increased labor and frequent damage to containment vessels caused when attempting to unload or transfer the product.

Mycotoxin, aflatoxins and many other toxins may cause contamination in livestock feed which may cost farmers billions of dollars a year worldwide in disease and productivity. An animal suffering from aflatoxin, mycotoxin or other toxin exposure often presents with a reduction in body weight, organ failure, immunosuppressive symptoms, and reproductive difficulties.

U.S. Publication Number 20060188549 to Block discloses an animal feed composition having utility in reducing the incidence of and treating the symptoms of fescue toxicosis in mammals that consume endophyte-infected fescue. However, the Block publication does not teach or disclose a distillers grain being used and the additives are not used in a dried distillers grain mixture as is disclosed in the present method.

A study at the University of Nebraska used dry distillers grain in cattle feed to replace corn, however, this study failed to disclose an additive in the dry distillers grain to help the flowability and to increase the feed value of the dry distillers gains, as is disclosed in the present method.

A need therefore exists for improved feed mixtures intended for livestock which comprise by-products of ethanol production and/or other fermentation processes. A method according to the present disclosure produces a consistent feed mixture which is beneficial to livestock not only from a nutritional standpoint, but also because the consistency of the feed makes it easier for the livestock to digest on an on-going. Further, the method improves the manner in which the material may be handled.

### SUMMARY OF THE DISCLOSURE

Compositions of matter and methods relating to the production of improved feed mixes for mammals, including without limitation cattle, sheep, poultry, fish, and swine. The compositions comprise a) a by-product of a fermentation process; and/or one zeolite; and/or one carbon.

A feed mix according to one embodiment of the disclosure is produced by combining zeolites and/or activated carbons with at least one by-product of ethanol production or other fermentations. Because of the hydrophilic nature of zeolites and activated carbons, the feed mixes provided have a lower moisture level than existing feed mixtures. Further, less energy consumption is required for the drying of the feed mix. As a result, the feed mix of the present method has a longer shelf life than existing feed mixes created from the by-products of the ethanol production or other fermentation processes, has an increased nutritional value and allows for easier handling and transportation.

### DETAILED DESCRIPTION

A process according to this disclosure involves the combination of zeolites and/or activated carbon with at least one by-product of ethanol-producing and/or other fermentations, which by-product(s) may comprise solids, liquids, or mixtures of solids and liquids and which are typically left-over after ethanol or another desired main product is extracted or separated from a mixture initially containing such by-products. Such by-products may be referred to herein as a by-product of a fermentation process. In one embodiment these by-products may comprise spent grains, including without limitation corn, wheat, rye, millet, and soybeans. In other embodiments, these by-products may comprise any non-grain plant material which comprise saccharides or polysaccharides when harvested, and include without limitation such plant material as sugar cane, beets, citrus fruits, pineapples and other cellulose products. In other embodiments, these by-products may comprise any non-grain material which comprise substantial amounts of starch when harvested, which starch or cellulose is converted to a sugar prior to fermentation by a malting process or any other known process for conversion of starch or cellulose to sugars, including without limitation, legumes and tubers, such as potatoes. By-products of ethanol-producing and/or other fermentations may include any materials falling within any of the foregoing classes.

In one embodiment, granulated and/or powdered zeolites and/or activated carbon are combined with at least one by-product of ethanol-producing and/or other fermentations, which may be distillers dried grains with solubles, distillers dried grains, distillers grain, including any combinations of the foregoing, at a rate of between about 0.01% to 10% by weight based on the total weight of the final composition. The combination of granulated and/or powdered zeolites and/or activated carbon are combined with at least one by-product of ethanol-producing and/or other fermentations at any temperature in the range of between about 0-300 degrees Celsius, and mixed using conventional mixing, until a substantially-uniform mixture results. The zeolites and/or activated carbons employed may be virgin, or may be pre-impregnated with or otherwise made to comprise minerals, vitamins, chemicals and/or other nutrients.

In general, according to this disclosure, the addition of at least one zeolite and/or activated carbon to by-products of ethanol-producing and/or other fermentations makes processing of such by-products more efficient and less energy-intensive. Currently, in a typical operation, the bottoms product of a distillation in which ethanol is recovered includes spent grains or other formerly-carbohydrate-containing materials, which are desirably to be dried to a moisture level in the range of between about 8% to 15% by weight based on the total weight of such bottoms products prior to their being packaged for disposal or use as animal feed or other uses. Addition of zeolites and/or activated carbons according to this disclosure during a drying process prior to the bottoms materials reaching a level of moisture within a prescribed final moisture specification causes some moisture to be taken up into the zeolites and/or activated carbons, which makes the entire mass reach a lower moisture content sooner than if conventional drying means only were employed, thus reducing the need for a substantial portion of the energy input normally expended and required in the drying process to achieve the prescribed final moisture specification.

According to one embodiment, zeolites and/or activated carbons are added to by-products of ethanol-producing and/or other fermentations and reduce caking and improve the flow of such by-products, accordingly decreasing or alleviating the need for special equipment and procedures for transporting, storing, and feeding such mixtures to animals.

### Wet Distillers Grains

The residue remaining in a process following the production of ethanol and/or other fermentations, from corn or other grains, is a high-moisture mix that is difficult to transport, handle, and process. Such residue generally comprises approximately over 50% moisture for Distillers Modified Wet Grain (“DMWG”) and approximately over 12% moisture for Distillers Dried Grains and Solubles (“DDGS”). Because the DMWG mix comprises a substantial water content, it has a short shelf-life and is not suitable for extended travel time and/or storage prior to consumption by livestock, owing to spoilage. Further, DMWG is prone to caking and does not flow well through handling equipment.

To address the problem with the lack of carbohydrates of by-products of ethanol-producing and/or other fermentations, zeolites and/or activated carbons to be added to such by-products in accordance with this disclosure are in some embodiments impregnated with at least one material selected from the group consisting of: urea, ammonia, carbohydrates, sugars and any other known dietary nutrient. In one embodiment, urea and/or ammonia impregnated into zeolites and/or activated carbons is carried into the digestive system of the animal following consumption of a combination provided hereby, and, through the action of bacteria is released in the animal's gut tract.

DDGS is a product obtained by condensing and drying the by-products remaining after removal of ethanol by distillation from yeast fermentation of grain or grain mixtures. One typical analysis of DDGS (courtesy of Badger State Ethanol, Inc.) is as follows:

| | |
|---|---|
| Dry matter % | 88.27 |
| Moisture % | 11.73 |
| Crude protein % | 31.05 |
| RUP % | 59.10 |
| NEL (Mcal/lb) | 1.0803 |
| NEG (Mcal/lb) | 0.7928 |
| NEM (Mcal/lb) | 1.1255 |
| NFC % | 21.74 |
| ADF % | 17.06 |
| NDF % | 34.31 |
| Fat % | 15.24 |
| Calcium % | 0.06 |
| Phosphorous % | 0.89 |
| Magnesium % | 0.38 |
| Potassium % | 1.23 |
| D.C.A.D. (mEq/lb) | −33.13 |

### Zeolites

Zeolites, or “molecular sieves” as they are sometimes called, are microporous crystalline solids with well-defined and known structures, and comprise a group of about 50 mineral types. Among them, clinoptilolite is one abundant and commonly-used zeolite. Zeolites typically contain oxygen, silicon and aluminum within their structural framework which may also include water molecules, cations, and/or other molecules. Zeolites frequently have pores, and the pore sizes of some zeolites are between about 3 Å and 10 Å in diameter.

According to this disclosure, zeolites are combined with at least one by-product of ethanol-producing and/or other fermentations. Any material that is generally recognized in the art as being zeolitic is suitable for use in providing a mixture according to this disclosure, including without limitation: biolite, clinoptilolite, natural and synthetic zeolites with a main proviso for suitability being the zeolites' possessing the ability to absorb substantial moisture while not being deleterious to an animal following their ingestion. An especially preferred zeolite is clinoptilolite. In one embodiment, the amount of zeolite combined with a by-product of ethanol-producing and/or other fermentations is any amount between about 0.01% and about 10% by weight based on the total weight of the final composition, including all percentages and ranges of percentages therebetween. A zeolite material as used in a combination herein described may have any average particle size between about 10 microns and about 2 millimeters, including all average particle sizes and ranges of average particle sizes therebetween. Thus, a zeolite as used herein may be a powdered zeolite or a granulated zeolite.

### Carbons

Activated carbons are non-hazardous, processed, carbonaceous products, having a porous structure and a large internal surface area. The volume of the pores of some common activated carbons is generally larger than about 0.2 ml g⁻¹, and the internal surface area is generally greater than about 400 m² g⁻¹. The width of the pores commonly range from between about 0.3 and several thousand nanometers. Carbons, as used herein, are typically comprised predominantly of an allotropic form of carbon, including graphitic carbon, which include activated charcoals and activated carbons, as such materials are generally recognized by those of ordinary skill in the art.

According to this disclosure, at least one carbon is combined with at least one by-product of ethanol-producing and/or other fermentations. Any material that is generally recognized in the art as being an activated carbon is suitable for use in providing a mixture according to this disclosure, including without limitation: activated coconut shell carbon, activated coal based carbon or any other suitable substrate that incorporated activated carbon with a main proviso for suitability being the carbons' possessing the ability to absorb substantial mycotoxins, aflatoxins, sulfur, or any bacteria or organism producing toxic byproducts and moisture while not being deleterious to an animal following ingestion. An especially preferred carbon is coconut shell carbon. In one embodiment, the amount of carbon combined with a by-product of ethanol-producing and/or other fermentations is any amount between about 0.01% and about 10% by weight based on the total weight of the final composition, including all percentages and ranges of percentages therebetween. A carbon material as used in a combination herein described may have any average particle size between about 5 microns and about 2 millimeters, including all average particle sizes and ranges of average particle sizes therebetween. Thus, a carbon as used herein may be a powdered carbon or a granulated carbon.

In some embodiments, at least one carbon and at least one zeolite are both combined with at least one by-product of ethanol-producing and/or other fermentations. For such embodiments, the total combined amounts of zeolite and carbon in a combination comprising a by-product of ethanol-producing and/or other fermentations is any amount between about 0.01% and about 10% by weight based on the total weight of the final composition, including all percentages and ranges of percentages therebetween.

As described herein, at least one of a carbon and a zeolite are combined with at least one by-product of ethanol-producing and/or other fermentations, and mixed until a substantially-uniform mixture results. Towards this end, any known mixing means may be used, including the use of extruders, auger mixers, mixers with sigma blades, mixers with shearing blades, and mixers which employ non-shearing blades. The mixing of components of a mixture described herein may be carried out at any temperature in the range of between about 0 degrees C. to about 300 degrees C., including all temperatures and ranges of temperatures therebetween. It is preferable in one embodiment to have the at least one by-product of ethanol-producing and/or other fermentations at a temperature of about 70 degrees C. prior to addition of either or both of the zeolite and carbon component(s).

A method according to the disclosure involves combining zeolites and/or activated carbons to at least one by-product from an ethanol-producing or other fermentation processes. In some embodiments, once combined, the zeolites (which may comprise hydrophilic zeolites) and/or activated carbons, absorb moisture from the high moisture feed mixture. The mixture which results, which is typically useful as feed for livestock, may be stored and/or transported for a longer time prior to consumption than if the zeolites and/or activated carbons were not present. When any one of the components of a mixture according to this disclosure has been pre-impregnated with at least one dietary nutrients, feed mixes having enhanced nutritional characteristics are produced from by-products which would have otherwise been wasted. Thus, a combination as provided herein enables both longer storage and transportation times in addition to increased feed value from a mixture suitable as livestock feed made using a by-product from an ethanol-producing or other fermentation processes.

In some embodiments, zeolites and/or carbons can be added and mixed with a by-product of an ethanol-producing or other fermentation process at any time during or after the drying process of such by-product, but is/are preferably added after drying such by-product to contain any amount of moisture between about 8% and about 15% water by weight based on weight of the total material. One preferred method according to this disclosure comprises the following four steps.

Step (1)—Obtaining or providing by-products from an ethanol-producing and/or other fermentation process. A carbohydrate-bearing raw material may be crushed, mashed, etc., mixed with water, and the mixture may be subjected to reduced pressure (vacuum conditions). While subjected to vacuum, the liquid may be caused to boil, evaporating water present and leaving a liquid having a high-carbohydrate concentration. This process may be repeated and sometimes it is preferable to repeat the process twice. Water and yeast may then be added to the remaining liquid, causing it to undergo fermentation to produce ethanol. After distillation to remove ethanol as a main desired product, the liquid (and/or solids) present in the distillation vessel or pot is sometimes discarded by manufacturing plants. In the present disclosure, this liquid (and/or solids when present) may serve as the by-products component in a feed mixture according hereto.

Step (2)—Combining zeolites and/or activated carbons to by-products of an ethanol-producing and/or other fermentation process to form an admixture. Zeolites and/or activated carbons may be added at any stage of the feed mix preparation process, but is/are preferably added after the by-products of a fermentation process have been reduced in moisture content to contain any level of moisture between about 8% and about 15% by weight based on the total weight of the by-product. In one embodiment, after the material is provided according to step 1, zeolites and/or activated carbons are combined with the by-product material in any order of addition. In one embodiment, any amount between about 0.01% and about 10% zeolite, and any amount between about 0.01% and about 10% of a carbon, each by weight based on the total weight of the final composition, are added to the by-product material within approximately 10 seconds to 10 minutes after the final distillation or drying process. For cases where increased drying of the by-product material is a desired goal, the zeolites and/or activated carbons are preferably added after partial dewatering of the by-products of ethanol production or other fermentation has been effected. In one embodiment, zeolites and/or activated carbons are added to the by-product of ethanol production or other fermentation at a rate of ⅛ oz to 5 oz of total zeolite and carbon per pound of by-product material. The zeolite)s) and/or carbon(s) may be virgin or impregnated with nutrients or adjuvants.

Step (3)—mixing, agitating, or mechanically working the admixture at any temperature in the range of between about 0° degrees C. and 300″ degrees Celsius for a sufficient amount of time to enable the admixture is substantially-uniform.

Step (4)—Curing the admixture by permitting passage of time sufficient to beneficially alter the flow properties of the admixture. In one embodiment, the by-product/zeolite/carbon mixture is mechanically mixed at any temperature in the range of between about 0° to 300° degrees Celsius for any amount of time between about 1 seconds and about 10 minutes. This temperature range and time is beneficial for curing the mixture to beneficially alter the flow properties and appearance of the final mixture, versus that of the by-product material prior to the addition of zeolite(s) and/or carbon(s). For example, the angle of repose is shown in the following table:

| | | |
|---|---|---|
| 0% zeolite | 2% zeolite | 4% zeolite |
| Average | Average | Average |

FLOWABILITY

| | | | |
|---|---|---|---|
| Angle of Repose | 44.43 | 43.00 | 42.33 |
| Aerated Bulk Density | 0.55 | 0.58 | 0.59 |
| Packed Bulk Density | 0.55 | .058 | 0.59 |
| Spatula (Before Impact) | 55.63 | 55.30 | 56.13 |
| Spatula (After Impact) | 52.60 | 57.37 | 54.60 |
| Angle of Spatula | 54.13 | 56.33 | 55.40 |
| Uniformity | 2.00 | 2.00 | 2.80 |
| Flow Index | 79.33 | 80.0 | 80.33 |

FLOODABILITY

| | | | |
|---|---|---|---|
| Angle of Fall | 37.13 | 36.40 | 35.73 |
| Angle of Difference | 7.30 | 6.60 | 6.60 |
| Dispersability | 14.10 | 17.40 | 18.67 |
| Flood Index | 60.33 | 61.00 | 61.92 |

*Provided by the United States department of Agriculture

As demonstrated by the above table, there is a decrease in the angle of repose as zeolite levels increased. Further, the curing process of the present method may be beneficial in that the cured mixture may having an increase in the flowability of the feed as well as increasing the feed value of the mixtures, compared to current existing mixtures. In another embodiment, mixing, agitating or mechanically working is carried out for a time period of any amount of time in the range of between about 1 second and 10 minutes. In another embodiment, curing is effectively achieved in a time period of any amount of time in the range of between about 10 seconds and 10 minutes. Preferably, the mixture cures by a time between about 1 second and about 10 minutes; however, it should be understood that a mixture provided hereby may require longer than 10 minutes to cure to provide increased flowability and a drier appearance.

In alternate embodiments, vitamins, minerals and/or other nutrition-enhancing substances and/or supplements are added to the zeolites and/or activated carbons prior to their admixture with a by-product from ethanol-producing or other fermentation processes, to increase the nutritional value of the resulting feed mix for livestock. In a further embodiment, sugar molasses may be added to a final product as described herein, in any amount. In further embodiments, a mixture as provided herein may comprise bentonite clay, which may be added to be present in any amount between about 0.01% and about 10% by weight of the final mixture comprising a by-product of ethanol-producing or other fermentation processes. In such embodiments, bentonite clay, zeolites and carbon may serve as an adjuvant in a drying agent or binding agent capacity for toxins in mammals, and also as a caking or binding agent to assist in pelletization of a mixture provided herein. While desiring not to be bound to any theory, and not to be interpreted as limiting of this disclosure, it is proposed that bentonite clay, zeolites and carbon assist in controlling effective mycotoxin and/or aflatoxin levels in the gastrointestinal tract of mammals.

In Table I below are provided example formulas of mixtures according to this disclosure, which are intended to be illustrative of the present disclosure and shall not be construed as delimitive thereof in any way:

TABLE I
Example Formulas

| Component | Example 1 | Example 2 | Example 3 | Example 4 |
|---|---|---|---|---|
| DDGS | ~40-90% | ~20-40% | ~20-40% | ~10-20% |
| Zeolite | ~.01-10% | ~.01-10% | ~.01-10% | ~.01-10% |
| Activated | ~.01-10% | ~.01-10% | ~.01-10% | ~.01-10% |
| Carbon | | | | |
| Bentonite | ~.01-10% | ~.01-10% | ~.01-10% | ~.01-10% |
| Other rations* | ~50% | ~50% | ~70% | ~70-80% |

*Rations means conventional livestock feed materials

In alternate embodiments, the total amounts of DDG, DDGS, and WDG may each be present in amounts up to about 95% by weight based on the total weight of the final composition.

It is preferable that water should be caused to have a pH of any value greater than or equal to about 7.5 upon addition of a composition as provided herein to water; however, any pH in the range of between about 6 and about 13 is acceptable, including all pH values and ranges of pH values therebetween. In one embodiment, pH is determined by adding 10 grams of a composition or material as herein described to 100 ml of distilled water @ 25° C. and gently stirred until a stable pH reading is obtained. Adjustment of pH may be achieved using additions of effective amounts of conventional acids and bases, including ammonia, hydroxides and carbonates of alkali and alkaline earth metals, mineral acids and organic acids, including their anhydrides such as CO₂.

Thus, the co-administration of a zeolite and a carbon along with a by-product of an ethanol-producing or other fermentation process to a mammalian subject it is an inherent result of this disclosure. As alternates to by-products of an ethanol-producing or other fermentation process, other foodstuffs may be substituted therefor, to provide compositions of matter comprising a conventional foodstuff, a zeolite, and a carbon, which compositions of matter are useful in promoting digestion and alleviating conditions of indigestion or discomfort which may result from mycotoxins, aflatoxins or other known or unknown pathogenic or chemically-related causes. Such other foodstuffs, including conventional foodstuffs, include any material recognized as suitable food for the mammal to which such composition is to be administered.

Although embodiments of the present method are described therein, it should be understood that various changes and modifications to the presently preferred embodiments will be apparent to those skilled in the art. Such changes and modifications may be made without departing from the spirit and scope of the present disclosure and without diminishing its attendant advantages. For example, where the word “about” is used in reference to a numerical value, the present disclosure includes embodiments in which occurrences of the word “about” is omitted from the context. It is, therefore, intended that such changes and modifications be covered by the appended claims.

I claim:

1. A composition of matter useful as a feedstock for mammals, including livestock which comprises:
a) by-product of a fermentation process; and
b) at least one zeolite or at least one carbon.

2. A composition according to claim 1 wherein said by-product of a fermentation process comprises at least one material selected from the group consisting of: condensed dry solubles, distillers dry grains with solubles, distillers grain with solubles, distillers dry grain, distillers grain, sugar cane pulp and sugar beet pulp.

3. A composition according to claim 1 wherein said zeolite is a zeolite selected from the group consisting of: clinoptilolite, natural zeolites or synthetic zeolites.

4. A composition according to claim 1 wherein said carbon is a carbon selected from the group consisting of: activated charcoal, activated carbon, graphite, wood carbon, bone carbon, coal carbon, coconut carbon.

5. A composition according to claim 1 further comprising:
d) a material selected from the group consisting of: clays and sugars wherein said clays comprise bentonite clay.

6. A composition according to claim 5 wherein said clay is present in any amount between about 0.01% and about 10% by weight based on the total weight of said composition, including all percentages and ranges of percentages therebetween.

7. A composition according to claim 1 wherein said zeolite is present in any amount between about 0.01% and about 10% by weight based on the total weight of said composition, including all percentages and ranges of percentages therebetween.

8. A composition according to claim 1 wherein said carbon is present in any amount between about 0.01% and about 10% by weight based on the total weight of said composition, including all percentages and ranges of percentages therebetween.

9. A composition according to claim 1 wherein said carbon and said zeolite are present in said composition in effective amounts to increase the flowability characteristics of said composition, as compared with said by-product of a fermentation process component.

10. A composition according to claim 1 wherein at least one of said at least one carbon and/or at least one zeolite is impregnated with a material selected from the group consisting of: vitamins, minerals, medicines, anti-biotics chemicals, nutrition-enhancing substances, dietary supplements, sugars and carbohydrates.

11. Method for preparing a feed product suitable for administration to mammals, which comprises:
providing a component which comprises a by-product of a fermentation process;
combining said by-product with at least one material selected from the group consisting of: a zeolite, and an/or activated carbon, to provide a substantially-uniform feed product mixture precursor; and
curing said feed product mixture precursor to provide a feed product by allowing the passage of a time period sufficient to cause an increase in the flowability characteristics of said mixture as compared with said by-product of a fermentation process component.

12. A method according to claim 11 wherein said combining includes mechanical mixing and wherein the amount of zeolite combined with said by-product is sufficient to cause said feed mixture to comprise any amount of zeolite between about 0.01% and about 10% by weight based on the total weight of said feed product, including all percentages and ranges of percentages therebetween.

13. A method according to claim 11, wherein the amount of activated carbon combined with said by-product is sufficient to cause said feed mixture to comprise any amount of activated carbon between about 0.01% and about 10% by weight based on the total weight of said feed product, including all percentages and ranges of percentages therebetween.

14. A method according to claim 1 further comprising:
providing said feed product as a feed for mammals.

15. A method according to claim 14 further comprising:
drying said feed product prior to its being provided as a feed for mammals.

16. A method according to claim 11 further comprising:
impregnating said at least one material with a substance selected from the group consisting of: vitamins, minerals, L-lysine, medicines, nutritional supplements, sugars, carbohydrates, anti-biotics, and urea prior to its being combined with said by-product.

17. A method according to claim 14, said at least one material being present in an effective amount to absorb at least one material selected from the group consisting of: ammonia, mycotoxins, sulfur, aflatoxins, from the gut tract of mammals following administration of said product to mammals.

18. A method according to claim 1 further comprising:
controlling the temperature of said feed product mixture precursor to be any temperature in the range of between about 0 degrees Celsius to about 300 degrees Celsius during said curing.

19. A method according to claim 11, wherein said zeolites comprise clinoptilolite zeolites or other natural zeolites or synthetic zeolites.

20. A method for relieving intestinal distress in a mammalian subject which comprises co-administration of a zeolite and a carbon, along with a foodstuff to said mammalian subject.
